(19) United States
(12) Patent Application Publication
(10) Pub. No.: US 2025/0103004 A1
(43) Pub. Date: Mar. 27, 2025

(54) GEAR ASSEMBLY AND TIMEPIECE

(71) Applicant: Casio Computer Co., Ltd., Tokyo (JP)

(72) Inventors: Yuta SAITO, Tokyo (JP); Masataka IIDA, Tokyo (JP)

(21) Appl. No.: 18/892,039

(22) Filed: Sep. 20, 2024

(30) Foreign Application Priority Data
Sep. 25, 2023 (JP) 2023-159313

(51) Int. Cl. G04B 13/02

(52) U.S. Cl. CPC G04B 13/02

(57) ABSTRACT

Disclosed is a gear assembly, including: a shaft with a gearwheel; a tube into which the shaft is inserted; and a washer interposed between the shaft and the tube in an axial direction of the shaft, wherein the washer has a higher hardness than the tube.

### BACKGROUND OF THE INVENTION

### Field of the Invention

The present disclosure relates to a gear assembly and a timepiece.

### Description of the Related Art

In the wheel train mechanism of mechanical timepieces, as disclosed in JP 2020-30092A, for example, a shaft such as a fourth wheel and pinion that operates a hand is supported by a support member such as a center tube in surface contact in the axial direction.

### SUMMARY OF THE INVENTION

A gear assembly according to one aspect of the present disclosure comprises:
a shaft with a gearwheel;
a tube into which the shaft is inserted; and
a washer interposed between the shaft and the tube in an axial direction of the shaft, wherein
the washer has a higher hardness than the tube.

A timepiece according to another aspect of the present disclosure comprises:
a wheel train mechanism that includes a gear assembly, the gear assembly including:
   a shaft with a gearwheel;
   a tube into which the shaft is inserted; and
   a washer interposed between the shaft and the tube in an axial direction of the shaft, wherein
   the washer has a higher hardness than the tube; and
a case that houses the wheel train mechanism.

Further features of the present invention will become apparent from the following description of exemplary embodiments (with reference to the attached drawings).

### BRIEF DESCRIPTION OF THE DRAWINGS

In the drawings:

FIG. 1 is a front view of a major portion of a timepiece according to an embodiment;

FIG. 2 is a cross-sectional view of a major portion of a region around a fourth wheel and pinion in a timepiece according to an embodiment; and

FIG. 3 is an enlarged view of the upper half of the fourth wheel and pinion according to the embodiment.

### DESCRIPTION OF THE EMBODIMENTS

Hereinafter, one or more embodiments of the present invention will be described with reference to the drawings.

The embodiment described below is provided with various limitations technically preferable for carrying out the present invention. However, the scope of the present invention is not limited to the embodiment below or illustrated examples.

### [Overall Structure of Timepiece]

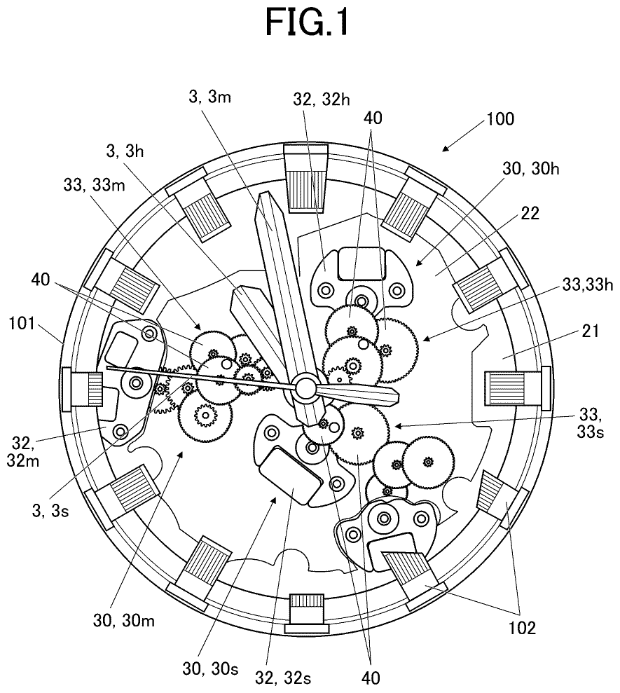

FIG. 1 is a front view of a major portion of a timepiece 100 according to the present embodiment. In FIG. 1, a dial, a portion of a main plate 21, and the like are omitted for easy understanding of the main structure.

As shown in FIG. 1, the timepiece 100 according to the present embodiment is an analog timepiece that displays time by pointing to an index 102 with a plurality of hands 3 (a second hand 3s, a minute hand 3m, and an hour hand 3h). The timepiece 100 includes a main body case 101 formed in a short cylindrical shape when viewed from the front.

Inside the main body case 101, the plurality of hands 3 and a plurality of drive mechanisms 30 that respectively rotate the plurality of hands 3 are housed.

The plurality of drive mechanisms 30 include a second hand drive mechanism 30s that rotates the second hand 3s, a minute hand drive mechanism 30m that rotates the minute hand 3m, and an hour hand drive mechanism 30h that rotates the hour hand 3h.

Each drive mechanism 30 includes a motor 32, which is a drive source, and a wheel train mechanism 33 that transmits the drive force of the motor 32 to the hand 3. Specifically, the second hand drive mechanism 30s includes the first motor 32s and the first wheel train mechanism 33s, the minute hand drive mechanism 30m includes the second motor 32m and the second wheel train mechanism 33m, and the hour hand drive mechanism 30h includes the third motor 32h and the third wheel train mechanism 33h.

Each wheel train mechanism 33 includes a plurality of gear assemblies 40.

For example, the first wheel train mechanism 33s of the second hand drive mechanism 30s includes gear assemblies 40 such as a fourth wheel and pinion (seconds wheel and pinion). The second wheel train mechanism 33m of the minute hand drive mechanism 30m includes gear assemblies 40 such as a second (center) wheel and pinion. The third wheel train mechanism 33h of the hour hand drive mechanism 30h includes gear assemblies 40 such as a minute wheel and an hour wheel.

The wheel train mechanism 33 may include a gear other than the gear assemblies 40. The gear in this case only needs to include at least a gearwheel and a shaft. The gearwheel and the shaft can be separate components as long as the gearwheel and the shaft are integrally combined.

### [Configuration of Gear Assembly]

As an example of the gear assemblies 40 according to the present embodiment, the configuration of a fourth wheel and pinion 40A will be described.

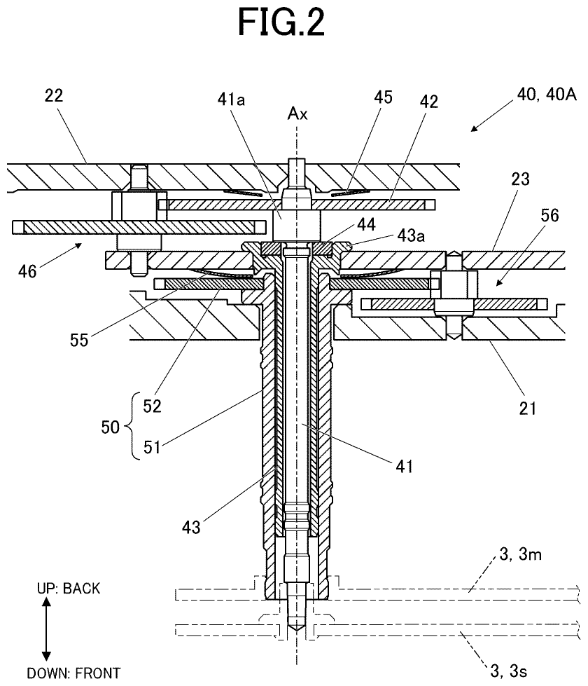

FIG. 2 is a cross-sectional view of a major portion of a region around the fourth wheel and pinion 40A in the timepiece 100. In FIG. 2, a portion of the third wheel train mechanism 33h of the hour hand drive mechanism 30h (e.g., minute wheel, and hour wheel) is omitted for easy understanding of the main structure.

As shown in this figure, the fourth wheel and pinion 40A includes a shaft 41, a gearwheel (spur gear) 42, and a tube (center tube) 43.

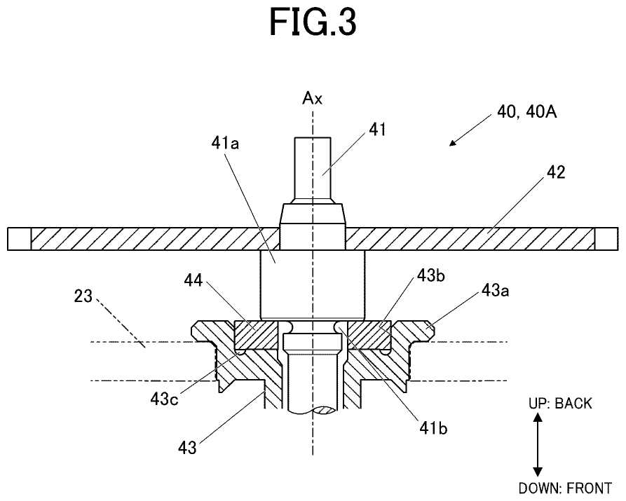

Hereinafter, the front-back direction of the timepiece 100 is referred to as the up-down direction, with the front side (the lower side in FIG. 2 and FIG. 3) called the “downward side” and the back side (the upper side in FIG. 2 and FIG. 3) called the “upward side.” The direction perpendicular to the central axis Ax of the shaft 41 along the up-down direction is referred to as the “radial direction” and the direction of rotation around the central axis Ax is referred to as the “circumferential direction.”

The shaft 41 is a shaft made of, for example, carbon tool steel (SK material), and is disposed along the up-down direction. The shaft 41 is supported by a train wheel bridge 22 and a second (center) wheel bridge 23 so that the shaft 41 is rotatable around the central axis Ax. The train wheel bridge 22 is disposed on the upward side with respect to the main plate 21 and supports the upward end of the shaft 41. The second wheel bridge 23 is disposed between the main plate 21 and the train wheel bridge 22 and supports a portion of the shaft 41 slightly above the center in the up-down direction via the tube 43.

The second hand 3s is fixed to the downward end of the shaft 41.

The gearwheel 42 is, for example, a spur gear made of silicon, and is attached to the upward portion of the shaft 41. More specifically, the gearwheel 42 is bonded to the top surface of a large-diameter portion 41a formed in the upward portion of the shaft 41. Here, the large-diameter portion 41a has the diameter larger than the diameter of a portion of the shaft 41 adjacent to the large-diameter portion. However, the material and fixing structure of the gearwheel 42 are not particularly limited.

The gearwheel 42 is urged downward by a washer 45 disposed between the gearwheel 42 and the train wheel bridge 22 above the gearwheel 42.

The gearwheel 42 meshes with an intermediate fourth wheel 46 connected to the first motor 32s. This allows the rotational force of the first motor 32s to be transmitted to the fourth wheel and pinion 40A, thereby rotating the second hand 3s at the downward end of the shaft 41.

The tube 43 is a substantially cylindrical member, into which about the lower half of the shaft 41, excluding the downward end, is inserted. The tube 43 is disposed coaxially with the shaft 41. The tube 43 is formed of a material softer than the shaft 41 (for example, stainless steel, brass, nickel, or the like).

The tube 43 includes, at its upward end, a large-diameter fixed portion 43a having a flange. The tube 43 is fixed to the second wheel bridge 23 by press-fitting the fixed portion 43a to the second wheel bridge 23 from above.

A second wheel and pinion 50 of the minute hand drive mechanism 30m (second wheel train mechanism 33m) is coaxially disposed in the tube 43.

The second wheel and pinion 50 includes a second wheel body (shaft) 51 in a cylindrical shape and a second gear (gearwheel) 52.

The second wheel body 51 is rotatably supported by the main plate 21. The shaft 41 and tube 43 are inserted into the second wheel body 51, and the shaft 41 is exposed through the downward end of the second wheel body 51. The minute hand 3m is fixed to the downward end of the second wheel body 51.

The second gear 52 is, for example, a spur gear made of silicon and is fixed to the upward portion of the second wheel body 51. The second gear 52 is urged downward by a washer 55 disposed between the second gear 52 and the second wheel bridge 23 above the second gear 52.

The second gear 52 meshes with an intermediate second wheel 56 connected to the second motor 32m. This allows the rotational force of the second motor 32m to be transmitted to the second wheel and pinion 50, thereby rotating the minute hand 3m at the downward end of the second wheel body 51.

FIG. 3 is an enlarged view of the upper half of the fourth wheel and pinion 40A.

As shown in this figure, the upward end of the tube 43 is in surface contact with the shaft 41 in the axial direction (up-down direction) via a washer 44 made of silicon having a higher hardness than the tube 43. The washer 44 is interposed between the shaft 41 and the tube 43 in the axial direction. Specifically, a counterbore 43b having a cylindrical shape that opens upward is formed in the upward surface of the fixed portion 43a of the tube 43, and the washer 44 is received (fitted) in the counterbore 43b.

An escape groove 43c is formed in a corner portion on the outer peripheral side of the bottom surface of the counterbore 43b. The escape groove 43c of the present embodiment is formed so that the outer peripheral end of the bottom surface of the counterbore 43b is recessed downward. That is, the escape groove 43c is formed so as to be recessed (downward) in the axial direction (up-down direction). However, the escape groove 43c may have any shape that can escape from (avoid contact with) the corner portion on the downward side of the outer circumference of the washer 44. For example, the escape groove 43c may have a shape that escapes radially outward, or escapes obliquely downward from the outer periphery.

The washer 44 is formed, for example, by lithography in a circular shape corresponding to the counterbore 43b. The inner diameter and outer diameter of the washer 44 are formed to have such a size that the washer 44 provides a required contact area with the seating surface of the shaft 41, which is the downward surface of the large-diameter portion 41a. The inner diameter of the washer 44 is formed to have such a size that the washer 44 has a sufficient gap to avoid contact with the shaft 41.

The washer 44 is bonded with adhesive in the counterbore 43b of the tube 43.

The washer 44 may be disposed in the counterbore 43b before press-fitting the tube 43 to the second wheel bridge 23. This allows the washer 44 to be suitably fixed in the counterbore 43b because the inner surface of the counterbore 43b contracts when the tube 43 is press-fitted. That is, the washer 44, while received in the counterbore 43b, is fixed in the counterbore 43b by press-fitting the fixed portion 43a, which is the end portion of the tube 43 on the side having the counterbore 43b.

An escape groove 41b is formed in a corner portion provided between the shaft 41 and the downward surface of the large-diameter portion 41a that contacts the washer 44. The escape groove 41b of the present embodiment is formed so that the corner portion provided between the shaft 41 and the downward surface of the large-diameter portion 41a is recessed inwardly. That is, the escape groove 41b is formed so as to be recessed in the direction intersecting the axis of the shaft 41. However, the escape groove 41b may have any shape that can escape from (avoid contact with) the corner portion on the upward side of the inner circumference of the washer 44. For example, the escape groove 41b may have a shape that escapes upward or obliquely upward toward the axis of the shaft 41.

### Technical Effects of the Embodiments

As described above, according to the present embodiment, the shaft 41 and the tube 43 are in contact with each other in the axial direction via the washer 44 having a higher hardness than the tube 43.

In the wheel train mechanism of mechanical timepieces disclosed in the aforementioned JP2020-30092A, high friction between the shaft and the support member increases the energy required for the hand movement and may also generate wear powder, shortening the life of the product. However, since the present embodiment has the above-described structure, friction between the tube 43 and the shaft 41 during the hand movement can be reduced as compared with the case where the tube 43 is in direct contact with the shaft 41. This allows the shaft 41 that includes the gearwheel 42 to be suitably supported.

Furthermore, the reduction of friction on the shaft 41 during the hand movement reduces the energy required for the hand movement and suppresses the generation of wear powder. This allows for energy saving and a long life of the product. This also makes it possible to reduce backlash, thereby improving the positional accuracy of the hands 3.

Here, the washer 45 is disposed between the train wheel bridge 22 and the gearwheel 42 for the purpose of braking the fourth wheel and pinion 40A in order to improve the hand movement accuracy of the second hand 3s. As described above, since the positional accuracy of the hands 3 is improved by adopting the configuration of the present embodiment, the washer 45, which has the common function, may not be used. In this case, the number of components can be reduced.

Instead of using the washer 44, the tube 43 itself may be replaced with a hard material. However, the tube 43 has a complex shape to avoid contact with the shaft 41 of the fourth wheel and pinion 40A and the second wheel body 51. Therefore, if the tube 43 is made of a hard material, it will not only be difficult to process the tube 43 but also difficult for the tube 43 to be press-fitted to the second wheel bridge 23. Using the washer 44 allows the above-described effects to be obtained relatively easily as compared with the case where the tube 43 itself is replaced with a hard material.

According to the present embodiment, the washer 44 is received (fitted) in the counterbore 43b formed in the upward end surface of the tube 43.

This avoids an increase in length in the up-down direction due to the insertion of the washer 44 as compared with the case where the tube 43 directly supports the shaft 41, thereby maintaining the thickness of the timepiece 100 at the same level. The counterbored hole 43b also allows the washer 44 to be suitably disposed in the up-down and radial directions.

According to the present embodiment, the tube 43 has the escape groove 43c that is formed in a corner portion on the outer peripheral side of the bottom surface of the counterbore 43b.

This allows the washer 44 to be suitably retained in the counterbore 43b.

That is, since the silicon washer 44 is very hard and manufactured by photolithography, the corner portion is not only likely to be chipped when stress is concentratively applied thereto but also difficult to chamfer. Thus, it is not desirable that the corner portion of the bottom surface of the counterbore 43b has a corner R that can interfere with (contact) the washer 44 at the time of assembly. However, it is inevitable that the corner R is formed in the corner portion in the normal cutting process. Therefore, an additional cutting process is performed on the corner portion of the counterbore 43b of the tube 43 to remove the corner R and provide the escape groove 43c. This makes it possible to avoid interference between the washer 44 and the counterbore 43b at the time of assembling. This allows the washer 44 to be suitably retained in the counterbore 43b without making it difficult to position the washer 44 by reducing the size of the washer 44 in order to avoid the corner R.

It is preferable that the machining direction of the escape groove 43c is in the up-down direction (axial direction) that coincides with the machining direction of the counterbore 43b. Making the machining direction of the escape groove 43c the radial direction requires an undercut against the machining direction of the counterbore 43b. On the other hand, setting the machining direction of the escape groove 43c to the axial direction allows the escape groove 43c to be formed relatively easily by cutting.

According to the present embodiment, the washer 44 is bonded to the tube 43 with adhesive. The escape groove 43c at the bottom surface of the counterbore 43b can be used as a reservoir groove for the adhesive.

This allows the adhesive to be suitably retained in the counterbore 43b, suppressing protrusion of excess adhesive from the counterbore 43b. Consequently, an occurrence of malfunction due to the adhesive protruded from the counterbore 43b can be suppressed.

According to the present embodiment, the shaft 41 is provided with the escape groove 41b in the inner peripheral corner portion of the surface that contacts the washer 44.

This prevents a corner portion of the insertion hole of the washer 44 from coming into contact with the shaft 41, thereby suppressing chipping of the corner portion.

According to the present embodiment, the washer 44 is made of silicon.

By using the washer 44 made of silicon having high lubricity, friction of the shaft 41 during the hand movement can be further reduced.

### [Others]

The embodiments to which the present invention can be applied are not limited to the above-described embodiments, and various modifications can be made without departing from the scope of the present invention.

For example, in the above embodiment, the washer 44 supporting the shaft 41 is made of silicon having a crystal lattice plane. However, the material of the washer 44 is not limited to silicon as long as the material has a higher hardness than the tube 43. For example, as a material having a crystal lattice plane, a wafer made of diamond may be used.

The material of the shaft 41 is not limited to the carbon tool steel material (SK material) and may be any metal having high hardness. The tube 43 may be made of metal having a lower hardness than the shaft 41.

In the above embodiment, the tube 43 and the shaft 41 are both provided with the escape groove to avoid contact with the washer 44. However, it is only required that at least one of the tube 43 and shaft 41 is provided with an escape groove in a place facing the corner portion of the washer 44.

In the above embodiment, the fourth wheel and pinion is given as an example of the gear assembly according to the present invention. However, the gear assembly of the present invention may also be applied to a gear assembly other than the fourth wheel and pinion in a wheel train mechanism. For example, the gear assembly of the present invention may be applied to a gear assembly in a wheel train mechanism of a time hand other than the second hand or may be applied to a gear assembly in a wheel train mechanism of a functional hand that displays various functions other than the time.

Further, the gear assembly according to the present invention is not limited to a gear assembly used in a wheel train mechanism of a timepiece and may be widely applied to a gear assembly having a structure in which a shaft having a gearwheel is supported by a tube (a member having a hole). In particular, the present invention may be suitably applied to a small gear mechanism in which it is difficult to adopt a complicated bearing structure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-159313, filed Sep. 25, 2023, which is hereby incorporated by reference wherein in its entirety.

What is claimed is:

1. A gear assembly, comprising:
a shaft with a gearwheel;
a tube into which the shaft is inserted; and
a washer interposed between the shaft and the tube in an axial direction of the shaft, wherein
the washer has a higher hardness than the tube.

2. The gear assembly according to claim 1, wherein
the tube has a counterbore on an end surface in the axial direction, and
the washer is received in the counterbore.

3. The gear assembly according to claim 2, wherein the tube has an escape groove in a corner portion on an outer peripheral side of a bottom surface of the counterbore.

4. The gear assembly according to claim 3, wherein the escape groove in the tube is provided so as to be recessed in the axial direction of the shaft.

5. The gear assembly according to claim 1, wherein the shaft has a large-diameter portion having a diameter larger than a diameter of a portion of the shaft adjacent to the large-diameter portion, and has an escape groove in a corner portion provided between the shaft and a downward surface of the large-diameter portion that contacts the washer.

6. The gear assembly according to claim 5, wherein the escape groove in the shaft is provided so as to be recessed in a direction intersecting an axis of the shaft.

7. The gear assembly according to claim 1, wherein the washer is made of silicon.

8. The gear assembly according to claim 2, wherein the washer is made of silicon.

9. The gear assembly according to claim 3, wherein the washer is made of silicon.

10. The gear assembly according to claim 5, wherein the washer is made of silicon.

11. The gear assembly according to claim 7, wherein
the shaft and the tube are made of metal, and
the tube has a lower hardness than the shaft.

12. The gear assembly according to claim 2, wherein
the washer is made of silicon, and
the washer, while received in the counterbore, is fixed in the counterbore by press-fitting an end portion of the tube on a side having the counterbore.

13. The gear assembly according to claim 12, wherein
the shaft and the tube are made of metal, and
the tube has a lower hardness than the shaft.

14. A timepiece, comprising:
a wheel train mechanism that includes the gear assembly according to claim 1; and
a case that houses the wheel train mechanism.

15. A timepiece, comprising:
a wheel train mechanism that includes the gear assembly according to claim 2; and
a case that houses the wheel train mechanism.

16. A timepiece, comprising:
a wheel train mechanism that includes the gear assembly according to claim 3; and
a case that houses the wheel train mechanism.

17. A timepiece, comprising:
a wheel train mechanism that includes the gear assembly according to claim 5; and
a case that houses the wheel train mechanism.

18. A timepiece, comprising:
a wheel train mechanism that includes the gear assembly according to claim 7; and
a case that houses the wheel train mechanism.

19. A timepiece, comprising:
a wheel train mechanism that includes the gear assembly according to claim 12; and
a case that houses the wheel train mechanism.
